(19) United States
(12) Patent Application Publication
(10) Pub. No.: US 2015/0219108 A1
(43) Pub. Date: Aug. 6, 2015

(54) CONTROL DEVICE FOR WORKING MACHINE

(71) Applicant: KAYABA INDUSTRY CO., LTD., Tokyo (JP)

(72) Inventor: Masayuki Kobayashi, Kanagawa (JP)

(73) Assignee: KAYABA INDUSTRY CO., LTD., Tokyo (JP)

(21) Appl. No.: 14/426,397

(22) PCT Filed: Feb. 13, 2014
(86) PCT No.: PCT/JP2014/053335

§ 371 Date: Mar. 6, 2015

(30) Foreign Application Priority Data
Mar. 15, 2013 (JP) 2013-053327

(51) Int. Cl. F04D 27/00; G05B 15/02

(52) U.S. Cl. CPC F04D 27/00; G05B 15/02

(57) ABSTRACT

A control device for a working machine includes a storage unit in which a constant used in a program for operating the working machine is stored, a control unit which is configured to control the operation of the working machine by executing the program using the constant stored in the storage unit, and a connector unit to which an external apparatus capable of inputting an update value for overwriting the constant stored in the storage unit is connected.

### TECHNICAL FIELD

The prevent invention relates to a control device for working machine which is operated by an electronic control.

### BACKGROUND ART

Conventionally, a working machine has been used which includes a drive device such as an engine or an electric motor and is operated by controlling the drive device by a control device.

JP2012-241339A discloses a hybrid working machine which includes a hydraulic pump to be driven by an engine and an electric motor for assisting the drive of the hydraulic pump by the engine and in which a hydraulic actuator is actuated by hydraulic oil discharged from the hydraulic pump. This hybrid working machine includes a control device for controlling the engine and the electric motor based on signals from various sensors.

### SUMMARY OF INVENTION

However, generally, in the case of updating a program used for the operation of a working machine, a control device of the working machine updates the entire program at once. Thus, even if it is desired to update a part of the program, the entire program needs to be updated at once, which has taken time and effort.

The present invention is developed in view of the above problem and aims to facilitate the update of a program of a control device of a working machine.

According to one aspect of the present invention, a control device for working machine for controlling the operation of a working machine, includes a storage unit in which a constant used in a program for operating the working machine is stored, a control unit which is configured to control the operation of the working machine by executing the program using the constant stored in the storage unit, and a connector unit to which an external apparatus capable of inputting an update value for overwriting the constant stored in the storage unit is connected.

### BRIEF DESCRIPTION OF DRAWINGS

FIG. 1 is a schematic configuration diagram of a fluid pressure control system of a hybrid construction machine to which a control device for working machine according to an embodiment of the present invention is applied,

FIG. 2 is a schematic configuration diagram of an assist/regeneration mechanism connected to the fluid pressure control system,

FIG. 3 is a block diagram of the control device for working machine according to the embodiment of the present invention, and

FIG. 4 is a flow chart of a constant update process executed by the control device for working machine according to the embodiment of the present invention.

### DESCRIPTION OF EMBODIMENTS

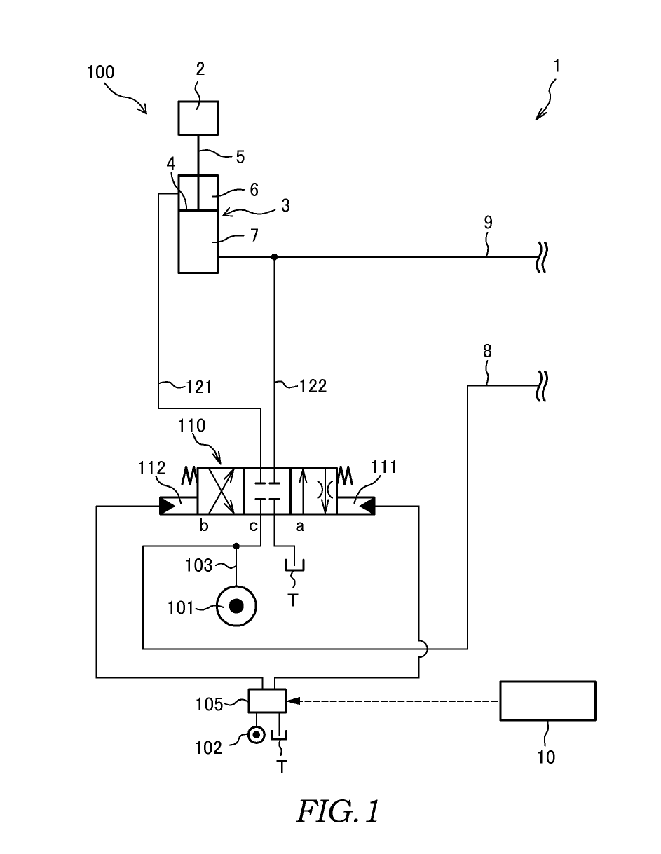

Hereinafter, a control device for working machine (hereinafter, merely referred to as a “control device”) 10 according to an embodiment of the present invention is described with reference to FIGS. 1 to 4.

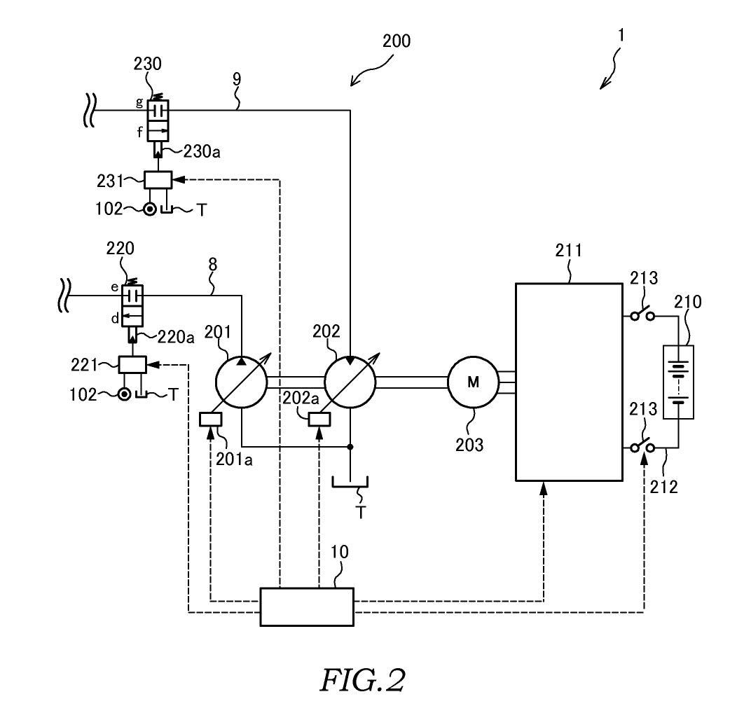

First, with reference to FIGS. 1 and 2, a hybrid construction machine 1 as a working machine, to which the control device 10 is applied, is described.

The hybrid construction machine 1 includes a fluid pressure control system 100 shown in FIG. 1 and an assist/regeneration mechanism 200 shown in FIG. 2.

The fluid pressure control system 100 is a device for controlling the operation of the hybrid construction machine 1. In the present embodiment, the hybrid construction machine 1 is a hydraulic working machine such as a hydraulic shovel. The fluid pressure control system 100 controls, for example, extending and contracting movements of a boom cylinder 3 as an actuator for driving a boom 2 (load) for an excavation attachment of a hydraulic shovel.

The fluid pressure control system 100 includes the boom cylinder 3, a main pump 101 for driving the boom cylinder 3 by discharging hydraulic oil as hydraulic fluid, a pilot pump 102, a main control valve 110, a main passage 103, a first passage 121, a second passage 122 and the control device 10 for controlling the operation of the hybrid construction machine 1.

The interior of the boom cylinder 3 is partitioned into a rod-side pressure chamber 6 and a bottom-side pressure chamber 7 by a piston 4 which slidably moves in the boom cylinder 3. A piston rod 5 is coupled to the piston 4. The boom 2 is coupled to the tip of the piston rod 5 located outside the boom cylinder 3.

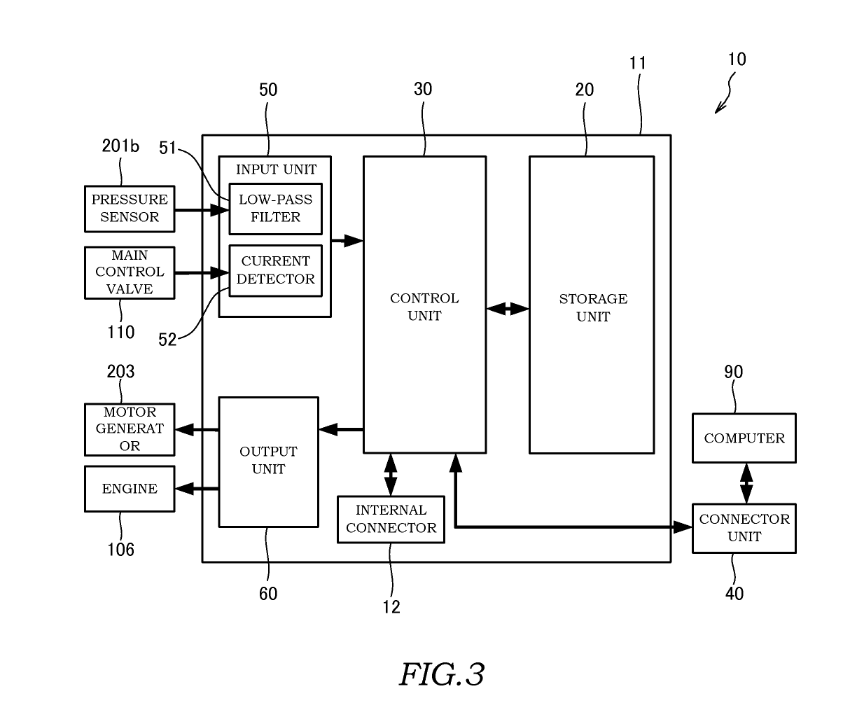

The main pump 101 and the pilot pump 102 are variable displacement hydraulic pumps which are hydraulic pressure supply sources for discharging the hydraulic oil and each capable of adjusting a discharge amount of the hydraulic oil by controlling an inclination angle of a swash plate. The main pump 101 and the pilot pump 102 are driven by an engine 106 (see FIG. 3) mounted in the hybrid construction machine 1.

The hydraulic oil discharged from the main pump 101 is supplied to the main control valve 110 through the main passage 103. In this way, the main pump 101 and the main control valve 110 are connected by the main passage 103. Besides the hydraulic oil discharged from the main pump 101, hydraulic oil discharged from an assist pump 201 of the assist/regeneration mechanism 200 (see FIG. 2) is introduced to the main passage 103 through a sub-passage 8.

The main control valve 110 and the rod-side pressure chamber 6 of the boom cylinder 3 are connected by the first passage 121, and the main control valve 110 and the bottom-side pressure chamber 7 of the boom cylinder 3 are connected by the second passage 122. A return passage 9 into which a part of the hydraulic oil discharged from the bottom-side pressure chamber 7 flows is connected to the second passage 122. The hydraulic oil flowing into the return passage 9 drives a regeneration motor 202 of the assist/regeneration mechanism 200 (see FIG. 2).

The main control valve 110 is a proportional valve for switching the supply and discharge of the hydraulic oil to and from the boom cylinder 3. The main control valve 110 is operated by a pilot pressure which is a hydraulic pressure of the hydraulic oil supplied from the pilot pump 102 to pilot chambers 111, 112 of the main control valve 110. The pilot pressure supplied to the pilot chambers 111, 112 is controlled by the control device 10 controlling a pilot electromagnetic valve 105 based on a lever operation by an operator of the hybrid construction machine 1.

When the pilot pressure is supplied to the pilot chamber 111, a valve mechanism of the main control valve 110 is switched to a position a. This causes the hydraulic oil discharged from the main pump 101 to be supplied to the rod-side pressure chamber 6 through the first passage 121 and the hydraulic oil in the bottom-side pressure chamber 7 to be discharged to a tank T through the second passage 122. As a result, the piston rod 5 in the boom cylinder 3 moves to a lower side in FIG. 1 and the boom cylinder 3 contracts to lower the boom 2.

If the pilot pressure is supplied to the pilot chamber 112, the valve mechanism of the main control valve 110 is switched to a position b. This causes the hydraulic oil discharged from the main pump 101 to be supplied to the bottom-side pressure chamber 7 through the second passage 122 and the hydraulic oil in the rod-side pressure chamber 6 to be discharged to the tank T through the first passage 121. As a result, the piston rod 5 in the boom cylinder 3 moves to an upper side in FIG. 1 and the boom cylinder 3 extends to elevate the boom 2.

It should be noted that since the main control valve 110 is a proportional valve, elevating and lowering speeds of the boom 2 can be continuously adjusted according to the amount of the lever operation by the operator.

On the other hand, when no pilot pressure is supplied to the pilot chambers 111, 112, the valve mechanism of the main control valve 110 is switched to a position c. This causes the supply and discharge of the hydraulic oil to and from the boom cylinder 3 to be cut off. As a result, the extension and contraction of the boom cylinder 3 are stopped and the boom 2 is held at a predetermined position.

As just described, the main control valve 110 has three switch positions, i.e. the contraction position a where the boom cylinder 3 is contracted, the extension position b where the boom cylinder 3 is extended and the cut-off position c where the load of the boom cylinder 3 is maintained.

The assist/regeneration mechanism 200 executes a regeneration control of recovering hydraulic energy of the hydraulic oil discharged from the bottom-side pressure chamber 7 as electrical energy during the contraction of the boom cylinder 3 and an assist control of applying an assist force during the extension of the boom cylinder 3.

As shown in FIG. 2, the assist/regeneration mechanism 200 includes the assist pump 201 for assisting the drive of the boom cylinder 3 by the main pump 101 by discharging the hydraulic oil, the regeneration motor 202 driven by the hydraulic oil discharged from the boom cylinder 3, a motor generator 203 drivable by the regeneration motor 202 and capable of driving the assist pump 201, a battery 210, an inverter 211, the return passage 9, and the sub-passage 8.

The assist pump 201 is a variable displacement hydraulic pump capable of controlling a discharge amount by controlling an inclination angle of a swash plate. The assist pump 201 is driven by the motor generator 203 and supplies the hydraulic oil to the main passage 103 through the sub-passage 8. The inclination angle of the swash plate of the assist pump 201 is controlled by an inclination angle controller 201a. The inclination angle controller 201a is controlled by the control device 10. By the control of the inclination angle of the swash plate of the assist pump 201, a discharge capacity of the assist pump 201 changes and a maximum value of a flow rate of the hydraulic oil capable of being discharged by the assist pump 201 changes.

A sub-control valve 220 for controlling the supply of the hydraulic oil to the main passage 103 is provided in the sub-passage 8. A valve mechanism of the sub-control valve 220 is switched to a communication position d where the hydraulic oil is supplied to the main passage 103 and a cut-off position e where the supply of the hydraulic oil to the main passage 103 is stopped according to a pilot pressure supplied from the pilot pump 102 to a pilot chamber 220a. The pilot pressure supplied to the pilot chamber 220a is controlled by the control device 10 controlling a pilot electromagnetic valve 221 based on the lever operation by the operator of the hybrid construction machine 1.

The regeneration motor 202 is a variable displacement hydraulic motor capable of controlling an output torque by controlling an inclination angle of a swash plate. The regeneration motor 202 is driven by the hydraulic oil discharged from the bottom-side pressure chamber 7 of the boom cylinder 3 and flowing through the return passage 9. The inclination angle of the swash plate of the regeneration motor 202 is controlled by an inclination angle controller 202a. The inclination angle controller 202a is controlled by the control device 10. By the control of the inclination angle of the swash plate of the regeneration motor 202, a discharge capacity of the regeneration motor 202 changes and a maximum value of a torque capable of being generated by the regeneration motor 202 changes.

A return control valve 230 for controlling the supply of the hydraulic oil to the regeneration motor 202 is provided in the return passage 9. A valve mechanism of the return control valve 230 is switched to a communication position f where the hydraulic oil is supplied to the regeneration motor 202 and a cut-off position g where the supply of the hydraulic oil to the regeneration motor 202 is stopped according to a pilot pressure supplied from the pilot pump 102 to a pilot chamber 230a. The pilot pressure supplied to the pilot chamber 230a is controlled by the control device 10 controlling a pilot electromagnetic valve 231 based on the lever operation by the operator of the hybrid construction machine 1.

The motor generator 203 is a rotary electric machine having a function as an electric motor for driving the assist pump 201 based on power of the battery 210 and a function as a generator for generating power by being driven by the regeneration motor 202.

Rotary shafts of the motor generator 203, the regeneration motor 202 and the assist pump 201 are respectively coaxially arranged. When the rotary shaft of the motor generator 203 rotates, the rotary shafts of the regeneration motor 202 and the assist pump 201 rotate in a linked manner. Similarly, when the rotary shaft of the regeneration motor 202 rotates, the rotary shafts of the motor generator 203 and the assist pump 201 rotate in a linked manner.

The motor generator 203 is connected to the battery 210 as a power storage device via the inverter 211. The battery 210 is configured by connecting a plurality of secondary battery cells capable of charging and discharging such as lithium ion batteries in series. A relay switch 213 for controlling an electrically connected state is provided on an electric wire 212 connecting the battery 210 and the inverter 211. The relay switch 213 is ON/OFF controlled by the control device 10.

The inverter 211 is controlled by the control device 10 and converts a direct current into an alternating current or an alternating current into a direct current. When the motor generator 203 functions as an electric motor, a direct current from the battery 210 is converted into a three-phase alternating current of an arbitrary frequency, which is supplied to the motor generator 203. On the other hand, when the motor generator 203 functions as a generator, a three-phase alternating current from the motor generator 203 is converted into a direct current, which is supplied to the battery 210.

Next, the control device 10 is described with reference to FIG. 3.

The control device 10 includes a storage unit 20 in which constants used in a program for operating the hybrid construction machine 1 are stored, a control unit 30 which controls the operation of the hybrid construction machine 1 by executing the program using the constants stored in the storage unit 20, a connector unit 40 to which a computer 90 as an external apparatus capable of inputting an update value for overwriting the constant stored in the storage unit 20 is connected, an input unit 50 to which various signals corresponding to an operating state of the hybrid construction machine 1 are input, and an output unit 60 which outputs signals for controlling the engine 106, the motor generator 203, and various valves and the like.

Further, the control device 10 includes a case 11 which houses the storage unit 20, the control unit 30, the input unit 50, and the output unit 60 and an internal connector 12 which is provided in the case 11 to update the program stored in the control unit 30.

The case 11 is arranged in the hybrid construction machine 1. The case 11 is sealed for dustproof and waterproof purpose.

The internal connector 12 is provided to update the entire program stored in advance in the control unit 30 at once. A computer is externally connected to the internal connector 12 via a tool. The entire program of the control unit 30 is updated by an operator opening the case 11, connecting the computer to the internal connector 12 via the tool, and operating the computer.

A pressure sensor 201b for detecting a discharge pressure of the assist pump 201, the main control valve 110, other various sensors and the like (not shown) are connected to the input unit 50. The input unit 50 includes a low-pass filter 51 for gradually reducing frequency components higher than a cutoff frequency out of signals used in controlling the hybrid construction machine 1 and a current detector 52 for detecting a current value of a feedback current from the main control valve 110. Although the low-pass filter 51 for processing a signal input from the pressure sensor 201b and the current detector 52 for detecting the feedback current from the main control valve 110 are shown as examples in FIG. 3, signals input to the input unit 50 are not limited to those.

The output unit 60 outputs a command from the control unit 30 to the motor generator 203, the engine 106, other various valves and the like (not shown).

The storage unit 20 is an E²PROM (Electrically Erasable Programmable Read-Only Memory) capable of storing state information of the hybrid construction machine 1 and the like. The E²PROM is a nonvolatile memory having a limit in the number of times of information rewriting (number of times of information update).

A plurality of constants as parameters for determining operation characteristics of the hybrid construction machine 1 controlled by the program are stored in the storage unit 20. Particularly, parameters having a high change frequency are stored in the storage unit 20.

Specifically, a threshold value of the pressure of hydraulic fluid for determining the start of the assist by the motor generator 203, a threshold value of the pressure of the hydraulic fluid for determining the start of the regeneration by the regeneration motor 202, a threshold value of the pressure of the hydraulic fluid for determining the start of the operation of the boom cylinder 3, the cutoff frequency of the low-pass filter 51, a map for setting a rotation speed characteristic of the motor generator 203 when the boom cylinder 3 operates, and a rotation speed of the engine 106 during an operation in which the hybrid construction machine 1 operates or during standby charging in which the hybrid construction machine 1 drives the regeneration motor 202 are stored as the constants having a high change frequency in the storage unit 20. Without limitation to these, various other threshold values, maps and the like may be stored as the constants having a high change frequency in the storage unit 20.

The control unit 30 controls the hybrid construction machine 1. The control unit 30 is a microcomputer including a CPU (Central Processing Unit), a ROM (Read Only Memory), and a RAM (Random Access Memory). The RAM stores data in the processing of the CPU. The ROM stores a control program and the like in advance. By operating the CPU, the RAM and the like in accordance with the program stored in the ROM, the control of the hybrid construction machine 1 is realized.

The control unit 30 is electrically connected to the storage unit 20, the input unit 50, and the output unit 60. The control unit 30 reads the constants stored in the storage unit 20 when the hybrid construction machine 1 is started. The control unit 30 executes the program for controlling the operation of the hybrid construction machine 1 using the constants read at startup.

An update value can be input from the connector unit 40 to the storage unit 20 any time during the operation of the hybrid construction machine 1. In the case of performing an operation of updating the constant of the storage unit 20 during the operation of the hybrid construction machine 1, the update value is not immediately applied to the control unit 30. The update value is applied to the ROM of the control unit 30 when the hybrid construction machine 1 is restarted. Thus, it can be prevented that the update value is applied during the operation of the hybrid construction machine 1 and an operation becomes unstable.

The connector unit 40 is drawn out to the outside of the case 11. The connector unit 40 electrically connects the control unit 30 and the computer 90. The computer 90 is directly serially connected to the connector unit 40 without via a tool or the like. Instead of this, the computer 90 may be connected to the control device 10 by a CAN (Controller Area Network), FlexRay (registered trademark) or the like. A signal for specifying the constant to be updated out of a plurality of constants stored in the storage unit 20 and a signal corresponding to the update value of this constant can be input from the connector unit 40 by the computer 90.

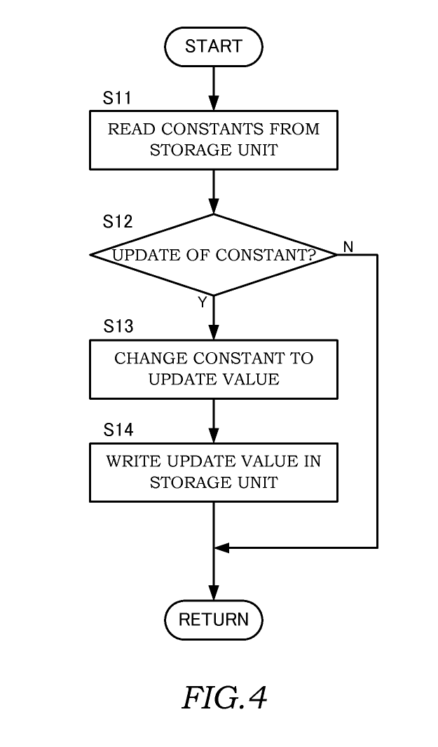

Next, a constant update process executed by the control device 10 of the hybrid construction machine 1 is described with reference to FIG. 4. The constant update process is performed in a cycle of several milliseconds during the operation of the hybrid construction machine 1.

In Step 11, the control unit 30 reads the values of the constants from the storage unit 20. It should be noted that although the control unit 30 reads the values of the constants in every execution cycle of the constant update process in FIG. 4, there is no limitation to this and the control unit 30 may read the values of the constants only at the first time when the hybrid construction machine 1 is started.

In Step 12, the control unit 30 compares the constant input from the computer 90 via the connector unit 40 and those read from the storage unit 20 in Step 11. If the update of the constant is determined in Step 12, a transition is made to Step 13. On the other hand, if no update of the constant is determined in Step 12, a return is made to Step 11.

In Step 13, the control unit 30 changes the constant to the update value. In Step 14, the control unit 30 writes the update value as a new constant in the storage unit 20 and, thereafter, a return is made to Step 11. In this way, the constant stored in the storage unit 20 can be updated during the operation of the hybrid construction machine 1.

As described above, in the control device 10, the update value for overwriting the constant stored in the storage unit 20 can be input using the computer 90 connected to the connector unit 40. Thus, only a part of the program can be updated by updating only the constant used in the program. Hence, it is not necessary to update the entire program at once, wherefore the program of the control device 10 can be easily updated.

Further, in the control device 10, the constant stored in the storage unit 20 can be updated not by connecting a computer to the internal connector 12 via a tool, but by directly serially connecting the computer 90 to the connector unit 40 provided outside the case 11. Thus, the case 11 sealed for dustproof and waterproof purpose needs not to be opened in updating the program. Therefore, the program of the control device 10 can be easily updated.

It should be noted that, at this point of time, the update value is not applied to the program stored in the ROM of the control unit 30 yet. As described above, the update value is applied to the ROM of the control unit 30 when the hybrid construction machine 1 is restarted.

Next, functions and effects depending on the type of the constant updated using the computer 90 connected to the connector unit 40 are described.

The control unit 30 can update at least any one of the threshold value of the pressure of the hydraulic fluid for determining the start of the assist by motor generator 203, the threshold value of the pressure of the hydraulic fluid for determining the start of the regeneration by the regeneration motor 202, and the threshold value of the pressure of the hydraulic fluid for determining the start of the operation of the boom cylinder 3.

In this way, timings of the start of the assist by the motor generator 203, the start of the regeneration by the regeneration motor 202, and the start of the operation of the boom cylinder 3 can be adjusted. Thus, adjustments can be made to improve operability and responsiveness of the hybrid construction machine 1.

The control unit 30 can update the cutoff frequency of the low-pass filter 51 for gradually reducing the components having a higher frequency than the cutoff frequency out of the signals used in controlling the hybrid construction machine 1.

In the case of application to the low-pass filter 51 for processing a signal from the pressure sensor 201b for detecting the discharge pressure of the assist pump 201, an adjustment can be made to suppress a variation of the discharge pressure due to pulsation. In the case of application to a low-pass filter for processing a feedback current of the main control valve 110 when the boom cylinder 3 is contracted, an adjustment can be made to suppress a variation due to noise or the like by lowering the cutoff frequency. In the case of application to a low-pass filter for processing a signal commanding the rotation speed of the motor generator 203 and a signal commanding the output torque of the motor generator 203, an adjustment can be made to suppress a shock due to a sudden variation by lowering the cutoff frequency.

The control unit 30 can update the map for setting the rotation speed characteristic of the motor generator 203 when the boom cylinder 3 operates.

In this way, the characteristic of the motor generator 203 in contracting the boom cylinder 3 can be changed and operability and a regeneration amount can be improved.

The control unit 30 can update the rotation speed of the engine 106 during an operation in which the hybrid construction machine 1 operates or during standby charging in which the hybrid construction machine 1 drives the regeneration motor 202.

By making the rotation speed of the engine 106 during an operation updatable in this way, adjustments can be made to reduce fuel consumption by reducing the rotation speed of the engine 106 and improve an output during the operation by increasing the rotation speed of the engine 106. Further, by making the rotation speed of the engine 106 during standby charging updatable in this way, adjustments can be made to reduce noise by reducing the rotation speed of the engine 106 and increase a charging amount by increasing the rotation speed of the engine 106.

As described above, in the control device 10, it is possible not only to update the entire program stored in the ROM of the control unit 30 at once, but also to overwrite the constant stored in the storage 20 with the update value. Thus, even if the operator does not have a high knowledge on the program, the operation characteristics of the hybrid construction machine 1 can be easily changed.

According to the above embodiment, the following effects are achieved.

In the control device 10, the update value for overwriting the constant stored in the storage unit 20 can be input using the computer 90 connected to the connector unit 40. Thus, only a part of the program can be updated by updating only the constant used in the program. Hence, it is not necessary to update the entire program at once, wherefore the program of the control device 10 can be easily updated.

Further, in the control device 10, the constant stored in the storage unit 20 can be updated not by connecting a computer to the internal connector 12 via a tool, but by directly serially connecting the computer 90 to the connector unit 40 provided outside the case 11. Thus, the case 11 sealed for dustproof and waterproof purpose needs not be opened. Therefore, the program of the control device 10 can be easily updated.

Further, since it is possible not only to update the entire program stored in the ROM of the control unit 30 at once, but also to overwrite the constant stored in the storage 20 with the update value. Thus, even if the operator does not have a high knowledge on the program, the setting of the hybrid construction machine 1 can be easily changed.

Embodiments of this invention were described above, but the above embodiments are merely examples of applications of this invention, and the technical scope of this invention is not limited to the specific constitutions of the above embodiments.

For example, although the control device 10 is applied to the hybrid construction machine 1 in the above embodiment, there is no limitation to this and the control device 10 may be applied to another working machine such as an electronically controlled mixer vehicle.

This application claims priority based on Japanese Patent Application No. 2013-053327 filed with the Japan Patent Office on Mar. 15, 2013, the entire contents of which are incorporated into this specification.

1. A control device for working machine for controlling the operation of a working machine, comprising:
a storage unit in which a constant used in a program for operating the working machine is stored;
a control unit which is configured to control the operation of the working machine by executing the program using the constant stored in the storage unit; and
a connector unit to which an external apparatus capable of inputting an update value for overwriting the constant stored in the storage unit is connected.

2. The control device for working machine according to claim 1, wherein:
a plurality of constants are stored in the storage unit; and
a signal for specifying the constant to be updated out of the plurality of constants and an update value of the specified constant are inputtable from the connector unit by the external apparatus.

3. The control device for working machine according to claim 1, wherein:
the external apparatus is a computer directly connected to the connector unit.

4. The control device for working machine according to claim 1, wherein:
the update value input from the connector unit is read into the control unit to be applied when the working machine is started.

5. The control device for working machine according to claim 1, further comprising:
a case which houses the storage unit and the control unit; and
an internal connector which is provided in the case for updating the program stored in the control unit;
wherein the connector unit is drawn out to the outside of the case.

6. The control device for working machine according to claim 1, wherein:
the working machine is a hybrid construction machine including a main pump that is configured to drive an actuator by discharging hydraulic fluid, an assist pump that is configured to assist the drive of the actuator by discharging the hydraulic fluid, a regeneration motor driven by the hydraulic fluid discharged from the actuator, and a rotary electric machine drivable by the regeneration motor and capable of driving the assist pump; and
the constant stored in the storage unit is a parameter for determining an operation characteristic of the hybrid construction machine controlled by the program.

7. The control device for working machine according to claim 6, wherein:
the parameter is at least any one of a threshold value of a pressure of the hydraulic fluid for determining the start of assist by the rotary electric machine, a threshold value of the pressure of the hydraulic fluid for determining the start of regeneration by the regeneration motor, and a threshold value of the pressure of the hydraulic fluid for determining the start of operation of the actuator.

8. The control device for working machine according to claim 6, further comprising a low-pass filter which gradually reduces a component having a higher frequency than a cutoff frequency out of a signal used in controlling the hybrid construction machine;
wherein the parameter is the cutoff frequency of the low-pass filter.

9. The control device for working machine according to claim 6, wherein:
the parameter is a map for setting a rotation speed characteristic of the rotary electric machine when the actuator is operated.

10. The control device for working machine according to claim 6, wherein:
the working machine further includes an engine that is configured to drive the main pump; and
the parameter is a rotation speed of the engine during an operation in which the hybrid construction machine is operated or during standby charging in which the hybrid construction machine drives the regeneration motor.
